(19) United States
(12) Patent Application Publication
(10) Pub. No.: US 2002/0193914 A1
(43) Pub. Date: Dec. 19, 2002

(54) Remote control powered parafoil aircraft

(76) Inventors: Tony L. Talbert, Orlando, FL (US); John Mark Kulo, Orlando, FL (US)

Correspondence Address: Edward M. Livingston, Esq., 628 Ellen Dr., P.O. Box 1599, Winter Park, FL, 32790, US

(21) Appl. No.: 10/045,777

(22) Filed: Jan. 11, 2002

Related U.S. Application Data
(60) Provisional application No. 60/261,682, filed on Jan. 11, 2001.

(51) Int. Cl. B64C 13/00

(52) U.S. Cl. 701/3; 701/2; 244/189

(57) ABSTRACT

A remote-control powered parafoil aircraft has an aircraft body (1) that is engine powered and hung with lines (2) from an air-expandable wing (3, 30). The lines include control lines (15) with which air flow and aerodynamic shape of the air-expandable wing are variable selectively from a foil controller (18, 19, 20) on the aircraft body for flight-mode control. Sight from a television camera (8) on the aircraft body is televised to a control unit (9) from which control data is transmitted selectively from proximate the control unit to the foil controller (14) with a multi-axis joystick or similar control, to an engine (6) on the parafoil body from an engine controller (24) and to an item servo (29) for control of optional items (45) on the aircraft body.

### CROSS-REFERENCE TO RELATED APPLICATION

This is application claims the benefit of U.S. Provisional Application No. 60/261,682, filed Jan. 11, 2001.

### BACKGROUND OF THE INVENTION

This invention relates to a televised remote-control aircraft having a propelled body suspended with lines from an air-expandable wing for un-manned agricultural spraying, dusting or analysis, military observation, photography, police surveillance, sports watching, demographic studies, industrial analysis, fire fighting and other uses with idealized speed, close control, high load capacity and ease of operation conveniently and reliably at low cost without licensing.

Remote-controlled aircraft are known and now proliferating for various surveillance and conveyance uses. None are known, however, to have televised remote operational control of a propelled body suspended with lines from an air-expandable wing having suspension-line control of aerodynamics for operational modes and on-board equipment control in a manner taught by this invention.

Examples of most-closely related known but different devices are described in the following patent documents:

| U.S. Pat. No. | Inventor | Issue Date |
|---|---|---|
| 6,119,976 | Rogers | Sep. 19, 2000 |
| 5,904,724 | Margolin | May 18, 1999 |
| 5,899,415 | Conway, et al. | May 04, 1999 |
| 5,884,863 | Fisher, et al. | Mar. 23, 1999 |
| 5,769,359 | Rutan, et al. | Jun. 23, 1998 |
| 5,620,153 | Ginsberg | Apr. 15, 1997 |
| 5,503,350 | Foote | Apr. 02, 1996 |
| 5,160,100 | Snyder | Nov. 03, 1992 |
| 4,601,443 | Jones, et al. | Jul. 22, 1986 |
| 4,175,722 | Higgins | Nov. 27, 1979 |

### SUMMARY OF THE INVENTION

Objects of patentable novelty and utility taught by this invention are to provide a remote-control powered parafoil aircraft which:

has flight control remotely with a multi-axis joystick or similar control;

has remotely televised operational control of onboard equipment selectively;

can takeoff and land in short distances from ground-like surfaces and from vehicles or even other aircraft during flight;

has a high load capacity per size, weight, cost and operating range;

can operate at variably controllable low speeds;

is highly maneuverable;

can be produced in a wide range of sizes, operating ranges and load capacities;

is easy to learn;

does not require licensing to operate;

is inexpensive;

can be fitted with a wide variety of use equipment; and

can be used for a wide variety of applications that include agricultural spraying, agricultural dusting, agricultural-crop analysis, animal herding, police surveillance, photography, sports surveillance, population studies, advertising, mapping, surveying, border patrol, mineral and oil prospecting, search and rescue, and military surveillance.

This invention accomplishes these objectives with a remote-control powered parafoil aircraft having an aircraft body that is engine powered and hung with lines from an air-expandable wing. The lines include control lines with which air flow and aerodynamic shape of the air-expandable wing are variable selectively from a foil controller on the aircraft body for flight-mode control. Sight from a television camera on the aircraft body is televised to a control unit from which control data is transmitted selectively from proximate the control unit to the foil controller with a multi-axis joystick or similar control, to an engine on the aircraft body from an engine controller and to equipment controls on the aircraft body from an equipment controller.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF DRAWINGS

This invention is described by appended claims in relation to description of a preferred embodiment with reference to the following drawings which are explained briefly as follows:

FIG. 1 is a front elevation view of a remote-control powered parafoil aircraft having a propeller thruster on an aircraft body suspended by lines from a parafoil wing that is ram-air inflated and is remotely controlled from a remote-control unit for dispensing crop-protection substance from a tank;

FIG. 2 is a side view of the FIG. 1 illustration;

FIG. 3 is a front elevation view of a remote-control powered parafoil aircraft having a propeller thruster on an aircraft body suspended by lines from a parafoil wing that is compressed-air inflated and is remotely controlled from a remote-control unit for dispensing crop-protection substance from a tank;

FIG. 4 is a side view of the FIG. 3 illustration;

FIG. 5 is a front view of a shrouded propeller thruster in relationship to an apposed-piston engine for powering the aircraft body;

FIG. 6 is a top view of the FIG. 5 shrouded propeller thruster in pushing relationship to a tricycle landing gear of the aircraft body on which an engine has an optional streamlined front cowling;

FIG. 7 is a front view of a shrouded fan thruster in relationship to an apposed-piston engine for powering the aircraft body;

FIG. 8 is a top view of the FIG. 7 shrouded fan thruster in pushing relationship to the tricycle landing gear of the aircraft body on which the engine has an optional streamlined cowling front; and

FIG. 9 is a diagram of the remote-control powered parafoil aircraft having optionally non-interference communication between a remote-control unit and an aircraft body operating a selection of operational items from an airborne platform with remote control.

### DESCRIPTION OF PREFERRED EMBODIMENT

Listed numerically below with reference to the drawings are terms used to describe features of this invention. These terms and numbers assigned to them designate the same features throughout this description.

| | |
|---|---|
| 1. Aircraft body | 24. Engine controller |
| 2. Lines | 25. Tank |
| 3. Parafoil | 26. Outlets |
| 4. Ram entrances | 27. Discharge conduit |
| 5. Ram-air compartments | 28. Item controller |
| 6. Engine | 29. Item servo |
| 7. Propeller | 30. Pumped-air wing |
| 8. Television camera | 31. Pumped-air compartment |
| 9. Control unit | 32. Leading edge |
| 10. Control communication | 33. Peripheral compartments |
| 11. Control transceiver | 34. Wheels |
| 12. Craft transceiver | 35. Rod frame |
| 13. Television screen | 36. Propeller duct |
| 14. Foil controller | 37. Pointed nacelle |
| 15. Control lines | 38. Turbine-like fan |
| 16. First line reel | 39. Fan blades |
| 17. Second line reel | 40. Base rim |
| 18. Control foil | 41. Output shaft |
| 19. First control foil | 42. Outside rim |
| 20. Second control foil | 43. Starter |
| 21. First reel servo | 44. Throttle |
| 22. Second reel servo | 45. Optional items |
| 23. Engine servo | 46. Non-interference system |

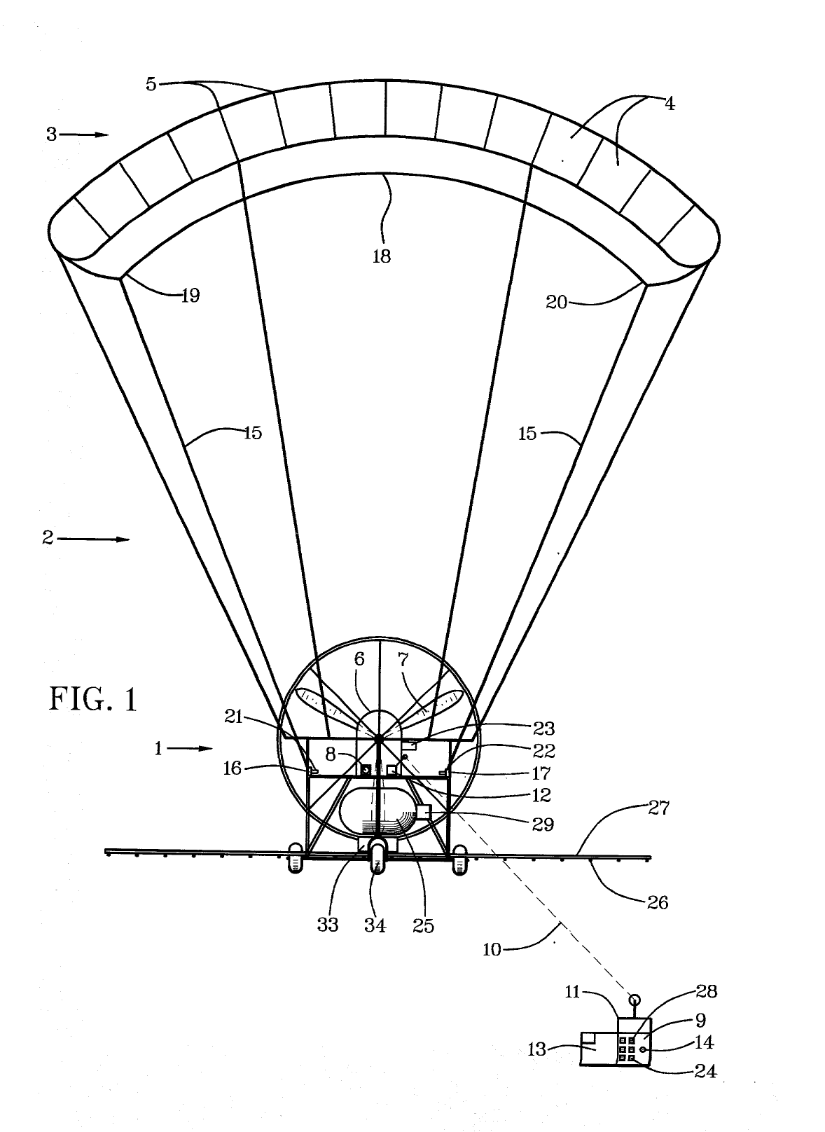

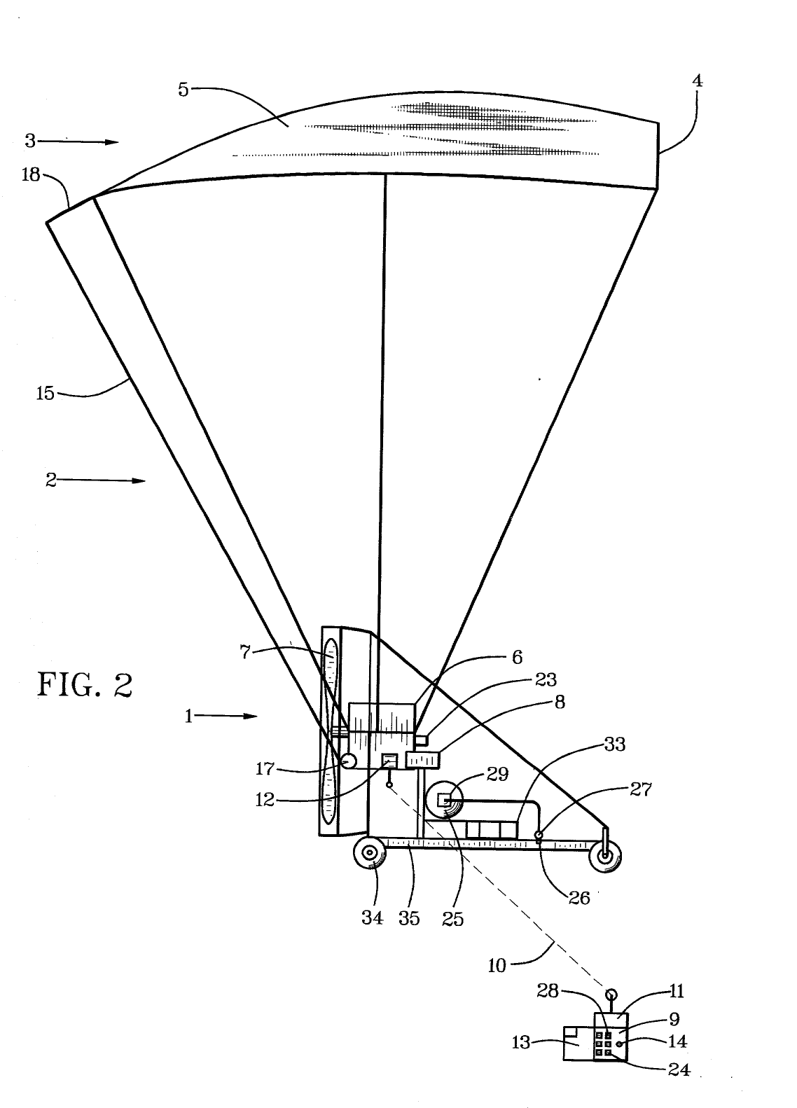

Referring to FIGS. 1-2, an aircraft body 1 is hung with lines 2 from an air-expandable wing that can include a parafoil 3 having ram entrances 4 to one or more ram-air compartments 5 for receiving ram air for expanding the parafoil 3 air-expandable wing.

There are a wide variety of air-expandable wings with a yet greater variety of detail designs that can be defined broadly as being parafoil for use with this invention. A currently popular parafoil 3 with a plurality of ram-air compartments 5 is popular justifiably not only as a result of its high lift-to-area ratio, but also because of its reliable ram-air inflation when used. Ram air, however, can resist forward movement, whether used for wings or for engines, and, therefore, can increase propulsion-power requirements for forward travel if overused or not utilized effectively. Resistance to forward travel that increases propulsion power is meritorious for carrying people or things downwardly because conversely, it deters and thereby slows forward movement advantageously for softness of landing. For this invention, however, economy of sustained forward travel is also critical. An air-expandable wing, therefore, is intended to include air expansion that is effective and efficient for forward travel in addition to high lift and soft landing. Detail drawings of either are not included.

The aircraft body 1 is engine-powered with an engine 6 coupled to a thruster that can include a propeller 7. The engine 6 can be whatever shaft-power engine is found to be most efficient and effective for a particular thruster at speeds and altitudes intended.

Vision of ground area selectively from the aircraft body 1 for desired remote guidance is provided by a television camera 8 on the aircraft body 1.

A control unit 9 is provided for remote control of the parafoil aircraft and equipment thereon selectively. There is control communication 10 intermediate a control transceiver 11 on the control unit 9 and a craft transceiver 12 on the aircraft body 1. There is television communication intermediate the television camera 8 and a television screen 13 which can be a picture-in-picture screen proximate the control unit 9.

A foil controller 14 that is preferably a joystick on the control unit 9, is in control communication through the control transceiver 11. The lines 2 include 5 control lines 15 intermediate at least one line reel, preferably a first line reel 16 and a second line reel 17, on the aircraft body 1 and at least one control foil 18 that can include a first control foil 19 and a second control foil 20 on the air-expandable wing which can include the parafoil 3.

The first line reel 16 is in foil-control communication from the foil controller 14 to a first reel servo 21 and the second line reel 17 is in foil-control communication from the foil controller 14 to a second reel servo 22.

From the craft transceiver 12, an engine servo 23 proximate the engine 6 on the aircraft body 1 is in engine-control communication by an engine controller 24 on the control unit 9.

At least one operational item, represented by a tank 25 with outlets 26 from a discharge conduit 27, on the aircraft body is controlled by an item controller 28, represented by a plurality of optional item controllers 28 on the control unit 9. An item servo 29 proximate the operational item on the aircraft body 1 is in control communication intermediate the control unit 9 and the item through its item servo 29.

The control communication 10 includes television communication, foil-control communication, engine-control communication and at least one item-control communication.

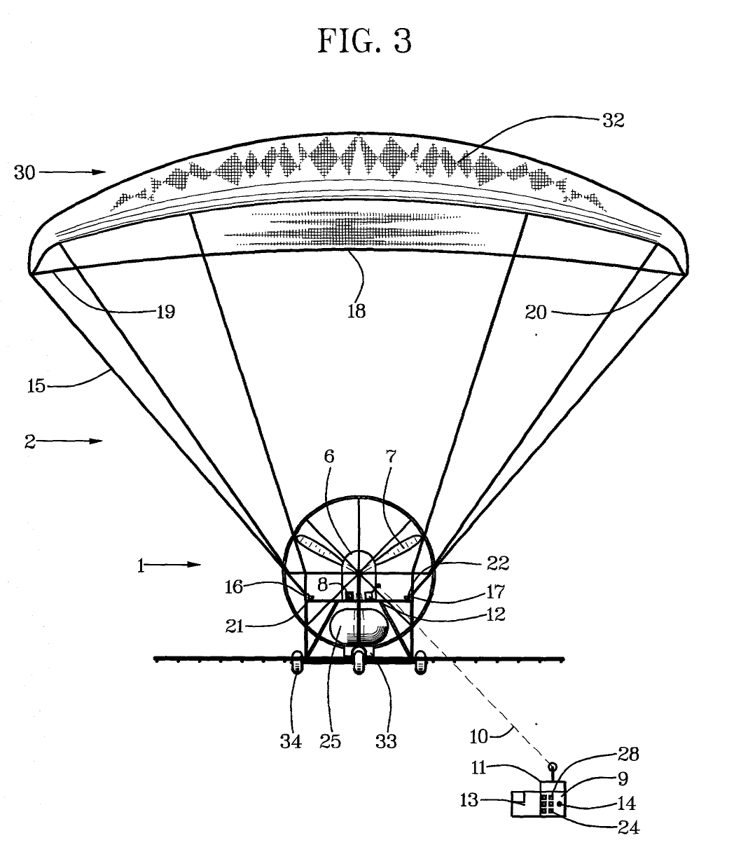

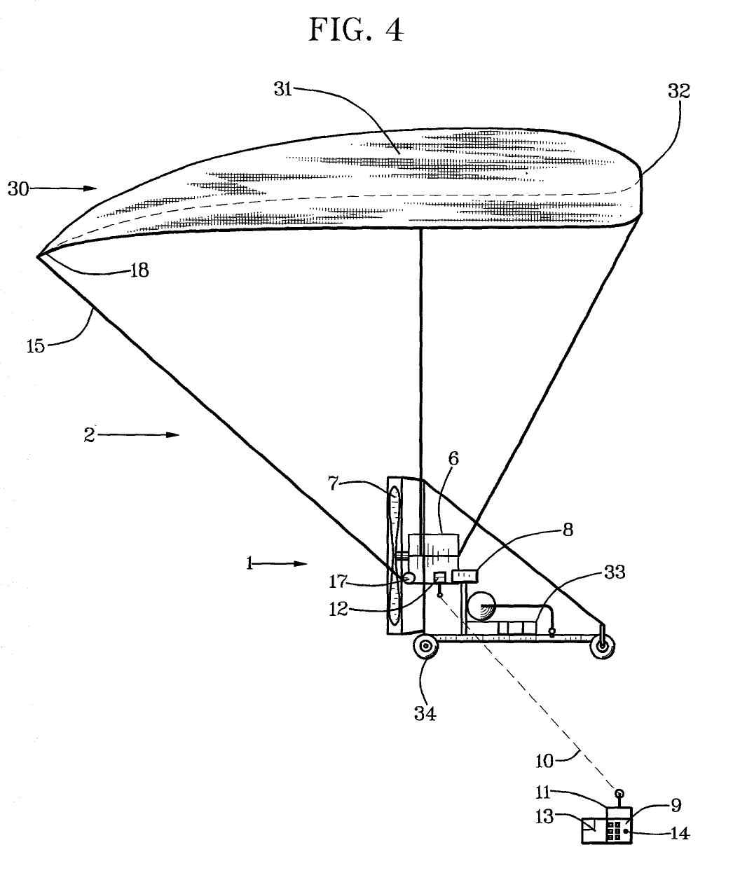

Referring to FIGS. 3-4, the air-expandable wing can include a pumped-air wing 30 that has at least one pumped-air compartment 31 for containing pumped air. The pumped-air compartment 31 can extend from a leading edge 32 to proximate the control foils 18 or 19 and 20. Optionally for some uses, the pumped-air compartment 31 can be extended to only a short distance from the leading edge 32, leaving a lift arc thereafter. Pressure of the pumped air need not be greater than one-to-five psi above ambient air pressure. For air inflation, an inexpensive, high-volume, low-pressure pump can be run with the engine 6 or, with some four-stroke engines, the engine exhaust can be used for inflation. Although requiring a slight time delay for inflation, variations of the pumped-air wing 30 can be made to provide considerable advantages of low propulsion costs, potentially greater carrying capacity, lower speed if desired for some uses, higher speed if desired and constructed aerodynamically for large areas. Emergency or quick-use forms of the pumped-air wing 30 can be cannister-filled if desired. Also, air could be hosed to the pumped-air wing 30 from a pump on the aircraft body 1 as needed while in flight.

Referring further to FIGS. 1-4, one or more peripheral compartments 33 can be provided for battery, starter, fuel and peripheral requirements for the engine 6 and for operational items. Although a tricycle landing gear with wheels 34 on a rod frame 35 is shown, different shapes and forms of the aircraft body 1 are foreseeable.

For whichever air-expandable wing is employed for this remote-control powered parafoil aircraft, guidance and control are achieved by selective pull of the first control foil 19 to turn in a first direction and by selective pull of the second control foil 20 to turn in a second direction. Pulling both equally at the same time causes high lift-drag for slow takeoff and landing and for high load capacity at decreased speeds.

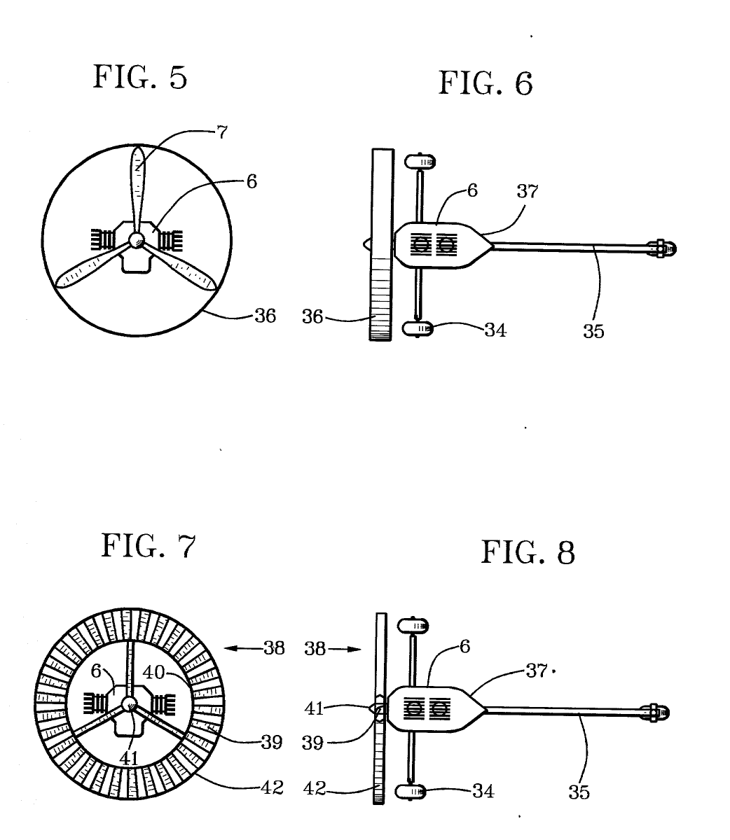

Referring to FIGS. 5-6, a propeller 7 can have a propeller duct 36 either attached to ends of blades for rotation or held steady on framework at ends of the blades for decreasing lateral thrust in proportion to linear thrust. The engine 6 can have a pointed nacelle 37 to house a starter.

Referring to FIGS. 7-8, the thruster can include a turbine-like fan 38 having a series of fan blades 39 extended radially outward from a base rim 40 that is coupled to an output shaft 41 of the engine 6. Also, the turbine-like fan 38 can include an outside rim 42 that is duct-like proximate outside ends of the fan blades 39. Optimum thruster selection depends largely on availability of quality of construction and on features of available engines. For some uses, the turbine-like fan 38 would be best, provided it can be produced at sufficiently low cost.

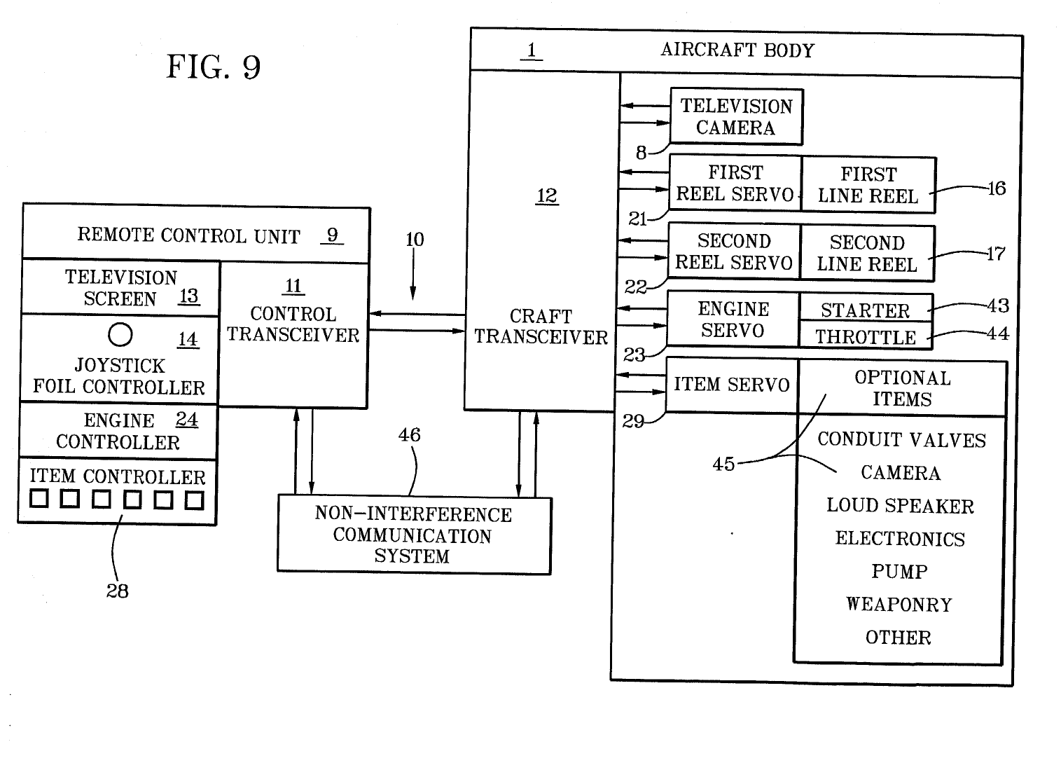

Referring to a system diagram of FIG. 9, a control transceiver 11 on the remote-control unit 9 has control communication 10 that preferably includes a non-interference communication system 46 with a craft transceiver 12 on the aircraft body 1. The non-interference communication system 46 relays control data from the joystick foil controller 14, from the engine controller 24 and from item controller 28 to the craft transceiver 12. The craft transceiver 12 relays the control data to the first reel servo 21 for the first line reel 16, to the second reel servo 22 for the second line reel 17, to the engine servo 23 for the starter 43 and the throttle 44 and to the item servo 29 for optional items 45 as programmed. Communication can be two-way feed back for any and all servos. The television camera 8 sends live video vision from the aircraft body 1 to the television screen 13 proximate the remote-control unit 9.

The control communication 10 and the non-interference communication system 46 include the television communication, foil-control communication, engine-control communication and at least one item-control communication.

Other control options may be used to govern the operation of the invention, including manual remote control, remote control with optional in-flight autopilot assistance and fully autonomous flight from an optional on-board computer with mission update or override capability from remote-control unit.

A new and useful remote-control powered parafoil aircraft having been described, all such foreseeable modifications, adaptations, substitutions of equivalents, mathematical possibilities of combinations of parts, pluralities of parts, applications and forms thereof as described by the following claims and not precluded by prior art are included in this invention.

What is claimed is:

1. A remote-control powered parafoil aircraft comprising:
an aircraft body that is hung with lines from an air-expandable wing;
the aircraft body being engine-powered with an engine coupled to a thruster on the aircraft body;
a television camera positioned on the aircraft body for viewing ground area from the aircraft body selectively;
a control unit for remote control of the parafoil aircraft and equipment thereon selectively;
a craft transceiver on the aircraft body;
a control transceiver on the control unit;
television communication intermediate the television camera on the aircraft body and a television screen proximate the control unit;
control communication intermediate the control transceiver and the craft transceiver selectively;
a foil controller on the control unit in control communication through the control transceiver;
the lines including control lines intermediate at least one line reel on the aircraft body and at least one control foil on the air-expandable wing;
the line reel being in foil-control communication from the foil controller to at least one reel servo;
an engine controller on the control unit in engine-control communication through the control transceiver;
an engine servo proximate the engine on the aircraft body in engine-control communication from the craft transceiver;
at least one operational item on the aircraft body;
an item controller on the control unit in item-control communication through the control transceiver; and
an item servo proximate the operational item on the aircraft body in control communication intermediate the control unit and the item.

2. The parafoil aircraft of claim 1 wherein:
the control communication includes the television communication, the foil-control communication, the engine-control communication and the at least one item-control communication.

3. The parafoil aircraft of claim 1 wherein:
the air-expandable wing includes a parafoil that has ram-air compartments with ram entrances for receiving ram air for expanding the air-expandable wing with ram air.

4. The parafoil aircraft of claim 1 wherein:
the air-expandable wing includes a pumped-air wing that has at least one pumped-air compartment for containing pumped air for expanding the air-expandable wing with pumped air.

5. The parafoil aircraft of claim 1 wherein:
the engine is one from a type of engines including an internal-combustion engine, a gas turbine engine and an electric engine.

6. The parafoil aircraft of claim 5 wherein:
the thruster includes a propeller.

7. The parafoil aircraft of claim 6 wherein:
the thruster includes a propeller duct proximate outside ends of blades of the propeller.

8. The parafoil aircraft of claim 1 wherein:
the thruster includes a turbine-like fan having a series of fan blades extended radially outward from a base rim that is coupled to an output shaft of the engine.

9. The parafoil aircraft of claim 8 wherein:
the turbine-like fan includes an outside rim that is duct-like proximate outside ends of the fan blades.

10. The parafoil aircraft of claim 1 wherein:
the air-expandable wing includes a parafoil.

11. The parafoil aircraft of claim 10 wherein:
the parafoil includes ram-air conveyances intermediate proximate a leading edge and proximate a trailing edge of the parafoil.

12. The parafoil aircraft of claim 1 wherein:
the air-expandable wing includes a trailing edge from which a control foil is flexible downwardly and upwardly in relationship to an aerodynamic-lift configuration of the air-expandable wing.

13. The parafoil aircraft of claim 12 wherein:
the reel servo includes a line reel for reeling the control line onto the line reel for pulling the control foil downwardly for causing lift drag and for unreeling the control line from the line reel for releasing the control foil upwardly for decreasing lift drag selectively.

14. The parafoil aircraft of claim 13 wherein:
the trailing edge includes a first control foil on a first side of the air-expandable wing and a second control foil on a second side of the air-expandable wing.

15. The parafoil aircraft of claim 14 wherein:
the reel servo includes a first reel servo with a first line reel for reeling at least one first control line onto the first line reel for pulling the first control foil downwardly for causing lift drag with the first control foil and for unreeling the first line reel for releasing the first control foil upwardly for decreasing the lift drag selectively; and
the reel servo includes a second reel servo with a second line reel for reeling at least one second control line onto the second line reel for pulling the second control foil downwardly for causing lift drag with the second control foil and for unreeling the second line reel for releasing the second control foil upwardly for decreasing the lift drag selectively.

16. The parafoil aircraft of claim 15 wherein:
the reel servo includes reeling control for causing the first line reel and the second line reel to be wound and unwound equally for causing equal increase and decrease of lift drag with the first control foil and the second control foil for controlling lift drag of the air-expandable wing in proportion to air speed of air-expandable wing and in proportion to thrust of the thruster selectively.

17. The parafoil aircraft of claim 16 wherein:
the reel servo includes reeling control for causing the first line reel and the second line reel to be wound and unwound unequally for causing unequal increase and decrease of lift drag with the first control foil and the second control foil for controlling direction of flight of the air-expandable wing by proportionately greater lift drag of the first control foil for turning the air-expandable wing in a direction of the first control foil and by proportionately greater lift drag of the second control foil for turning the air-expandable wing in a direction of the second control foil selectively.

18. The parafoil aircraft of claim 15 wherein:
the reel servo includes reeling control for causing the first line reel and the second line reel to be wound and unwound unequally for causing unequal increase and decrease of lift drag with the first control foil and the second control foil for controlling direction of flight of the air-expandable wing by proportionately greater lift drag of the first control foil for turning the air-expandable wing in a direction of the first control foil and by proportionately greater lift drag of the second control foil for turning the air-expandable wing in a direction of the second control foil selectively.

19. The parafoil aircraft of claim 1 wherein:
the foil controller includes a multi-axis joystick.

20. The parafoil aircraft of claim 1 wherein:
the engine controller includes a throttle for controlling speed and power output of the engine.

21. The parafoil aircraft of claim 1 wherein: the engine controller includes a starter and starter motor.

22. The parafoil aircraft of claim 1 wherein:
the operational item includes a valve on a tank having fluid communication to a plurality nozzles on a on a discharge bar.

23. The parafoil aircraft of claim 1 wherein:
the operational item includes a selection of operational items that is supportable on the aircraft body and operable remotely with the item controller.

24. The parafoil aircraft of claim 1 and wherein:
the control communication includes non-interference communication intermediate the control transceiver and the craft transceiver.

25. The parafoil aircraft of claim 24 wherein:
the non-interference communication includes a frequency-hopping communication system.

26. The parafoil aircraft of claim 25 wherein: the frequency-hopping communication includes sufficiently rapid and short-duration of radio frequencies to prevent obstructive interference with other radio frequencies in use.

27. A remote-control powered parafoil aircraft comprising:
an aircraft body that is hung with lines from a parafoil that is ram-air expandable;
the parafoil includes ram-air conveyances intermediate proximate a leading edge and proximate a trailing edge of the parafoil;
the aircraft body being engine-powered with an internal-combustion engine coupled to a thruster;
the lines including control lines intermediate at least one line reel on the aircraft body and at least one control foil on the parafoil;
a television camera positioned on the aircraft body for viewing ground area from the aircraft body selectively;
a control unit for remote control of the parafoil aircraft and equipment thereon selectively;
a craft transceiver on the parafoil aircraft;
a control transceiver on the control unit;
television communication intermediate the television camera and a television screen proximate the control unit;
operational control transmission intermediate the control transceiver and the craft transceiver selectively;
a foil controller in control communication with the control transceiver;
the lines including control lines intermediate at least one line reel on the aircraft body and at least one control foil on the air-expandable wing;
the line reel being in foil-control communication from the foil controller to at least one reel servo;
an engine controller on the control unit in engine-control communication with the control transceiver;
an engine servo on the aircraft body in engine-control communication from the craft transceiver;
at least one operational item on the aircraft body;
an item controller on the control unit in item-control communication with the control transceiver; and
an item servo on the aircraft body in control communication intermediate the control transceiver the item.

28. The parafoil aircraft of claim 27 wherein:
the control communication includes the television communication, the foil-control communication, the engine-control communication and the at least one item-control communication.

29. The parafoil aircraft of claim 27 wherein:
the thruster includes a propeller.

30. The parafoil aircraft of claim 27 wherein:
the parafoil includes ram-air conveyances intermediate proximate a leading edge and proximate a trailing edge of the parafoil;
the trailing edge includes the control foil that is flexible downwardly and upwardly in relationship to an aerodynamic-lift configuration of the parafoil.

31. The parafoil aircraft of claim 27 wherein:
the reel servo includes a first reel servo with a first line reel for reeling at least one first control line onto the first line reel for pulling the first control foil downwardly for causing lift drag with the first control foil and for unreeling the first line reel for releasing the first control foil upwardly for decreasing the lift drag selectively;
the reel servo includes a second reel servo with a second line reel for reeling at least one second control line onto the second line reel for pulling the second control foil downwardly for causing lift drag with the second control foil and for unreeling the second line reel for releasing the second control foil upwardly for decreasing the lift drag selectively;
the reel servo includes reeling control for causing the first line reel and the second line reel to be wound and unwound equally for causing equal increase and decrease of lift drag with the first control foil and the second control foil for controlling lift drag of the parafoil in proportion to speed of parafoil and in proportion to thrust of the thruster selectively; and
the reel servo includes reeling control for causing the first line reel and the second line reel to be wound and unwound unequally for causing unequal increase and decrease of lift drag with the first control foil and the second control foil for controlling direction of flight of the parafoil by proportionately greater lift drag of the first control foil for turning the parafoil in a direction of the first control foil and by proportionately greater lift drag of the second control foil for turning the parafoil in a direction of the second control foil selectively.

32. The parafoil aircraft of claim 27 wherein:
the manual controller includes a multi-axis joystick, a throttle for controlling speed and power output of the engine; and
the engine controller includes a starter and starter motor.

33. The parafoil aircraft of claim 27 wherein:
the operational item includes a plurality of spray nozzles on a spray tube in fluid communication with a spray container on the aircraft body.

34. The parafoil aircraft of claim 27 wherein:
the operational item includes a selection of items that is operable remotely with the operational controller and supportable on the aircraft body.

35. The parafoil aircraft of claim 27 and further comprising:
non-interference communication intermediate the control transceiver and the craft transceiver.

36. The parafoil aircraft of claim 34 wherein:
the non-interference communication includes frequency-hopping communication system.

37. A remote-control powered parafoil aircraft comprising:
an aircraft body that is hung with lines from an air-expandable wing with suspension-line control of suspension pull of at least one control foil with a foil servo for control of lift and direction of the aircraft;
a television camera on the aircraft body with televised communication intermediate an aircraft transceiver on the aircraft body and a control transceiver on a remote-control unit;
at least one select operational item with an item servo in communication with the aircraft transceiver on the aircraft; and
item-control communication intermediate the control transceiver and the aircraft transceiver.

38. The parafoil aircraft of claim 1 wherein:
the operational item includes a hopper and means for dispersing dry material from a group including granular chemicals, pellet chemicals, fertilizer, seeds and microbes.
